(19) United States
(12) Patent Application Publication
(10) Pub. No.: US 2002/0042776 A1
(43) Pub. Date: Apr. 11, 2002

(54) System and method for unifying electronic payment mechanisms

(76) Inventors: Kevin K.M. Woo, Surrey (CA); Alan L. Swain, Richmond (CA)

Correspondence Address: FASKEN MARTINEAU DuMOULIN LLP, Toronto Dominion Bank Tower, Suite 4200, Toronto-Dominion Centre, Box 20, Toronto, ON, M5K 1N6, CA

(21) Appl. No.: 09/955,587

(22) Filed: Sep. 19, 2001

(30) Foreign Application Priority Data
Sep. 19, 2000 (CA) 2,320,000
Dec. 29, 2000 (CA) 2,329,895

(51) Int. Cl. G06F 17/60

(52) U.S. Cl. 705/40

(57) ABSTRACT

A method for unifying payment transactions between a customer and a merchant, the transactions using customer information stored in one or more electronic wallets, the method comprising the steps of; Providing to the merchant an entity having a unifying interface to the one or more electronic wallets, the entity communicating with both the one or more electronic wallets and the merchant; and the entity collecting customer information from the one or more electronic wallets and payment transaction details from the merchant and processing the transaction in a financial institution.

The present invention relates to electronic transaction systems, and more particularly, to a system and method for unifying payment mechanisms between clients, merchants and financial institutions.

### BACKGROUND OF THE INVENTION

Point of sale systems (POS) have become almost universally adopted in various merchant systems. While traditional merchant systems require customers to be present at the merchant's premises, a wireless merchant system has mobile terminals that allows electronic payment to be made away from the merchant premises. This creates new business opportunities for the merchant. For example, Internet shopping with “payment at the door” opens new marketing channels with increased sales. We are all familiar with the delivery of pizza and other food stuffs ordered from a vendor by telephone and delivered to the customer's home where it is paid for by cash, credit or debit card payments.

A wireless merchant system typically comprises of one or more wireless POS terminals connected via a wireless network through a gateway to a financial transaction server (FTS), which is typically the merchant's bank and often referred to as the acquiring bank. One of the benefits of these wireless POS systems is that the customer is not always required to have cash on hand. Further, the POS system is normally integrated with the merchant's payment transaction server and allows various electronic reconciliation and reduction of paperwork for the merchant.

One of the disadvantages, however, of the traditional POS terminal is that it is relatively expensive, runs a proprietary protocol and has to be obtained from one of a limited number of suppliers.

Internet based payment transactions are growing compared to traditional POS type transactions. Internet transactions have three main components: the client, the merchant, and the financial institution. The client initiates a web-based payment over the Internet on the merchant's web site. The client also enters personal information such as billing address, shipping address, and credit card information. The role of the merchant web site is to facilitate the payment via the financial institution. Using the client's information, the merchant web site fills in the necessary details of the payment transaction and sends the transaction request to the financial institution.

As Internet payment transaction becomes more widespread, larger merchants started to offer client's user accounts. The user accounts were the first instances of what is called client wallets or electronic wallets. Clients were able to create a user account—the account would hold both the client's information such as billing address, shipping address, and credit card information. Once the client had selected the items or services from the merchant's web site, the client could authorize the payment transaction using their accounts. The clients would access their accounts by providing a user ID and a password.

A limiting factor of the client accounts were that they were merchant specific. The client account could only be used for the specific merchant. Therefore, an account needed to be created for each merchant web site. Due to this deficiency, third party vendors started to offer generic client wallets, as for example, the MBNA wallet™ and the Next Card Concierge™.

There are three components to the generic wallet server architecture: the cardholder, the client wallet server, and the merchant website. The cardholder represents the owner of the client wallet sever account. The cardholder first initiates communications with the merchant website. In most cases, the cardholder selects the items or services from the merchant website. When a payment transaction is required, the cardholder interacts with his or her client wallet server. The particular merchant website is also communicated to the client wallet server automatically. The next step is the client wallet server to merchant website communications. In this step, the client's information is sent to the merchant website. The final step is the merchant performing the payment transaction.

Thus, client wallets provided a mechanism whereby clients enter their personal information once and have the information sent to any merchant that requested it. Client wallets would be hosted on a server separate from any merchant web site. At the time of payment authorization, the merchant's web site would prompt the client for personal information. This request from the merchant's web site would trigger communications between the client wallet server and the merchant's web site and client information would then be passed to the merchant's web site.

One of the limitations of these generic wallets is their incompatibility with a variety of merchant systems. The communications API provided by wallet server vendors tend to be proprietary. Therefore, each merchant wanting to support the wallet server must conform to the vendors specific API. If a merchant wishes to support more than one wallet server, the merchant must write to each of the different wallet server APIs.

Due to these compatibility problems, adoption rates by merchants for support of wallet servers is slow. In many cases, merchants may only wish to support certain features of the API and not the full set of features. This results in a very unsatisfactory user experience. In some cases, the wallet servers may satisfy all of the necessary information requested by a merchant. In other cases, the wallet server may fill in only some information fields, leaving the user to fill in the rest of the information fields.

There are also security problems associated with client wallet servers. One security concern is between the user of the wallet server and the wallet server itself. In most cases, users gain access to their wallet servers by simply supplying the user ID and password. Internet security (SSL) may be used, but it is only used to authenticate the entity hosting the wallet server.

Another security concern arises as a result of the hosting of the wallet servers. There are currently no requirements as to where wallet servers are hosted. Wallet servers can either exist on a server or on a client device such as a PDA. As wallet servers contain sensitive client information such as address information and credit card information, it is vulnerable to attack.

In the generic wallet server architecture, the client wallet server is not involved with the payment transaction itself. It is only responsible for the exchange of client information with the merchant website. It is the responsibility of the merchant website to perform the payment transaction.

Once again the cost of supporting the various different generic wallets and the cost of ensuring effective payment processing is the responsibility of the merchant.

Another disadvantage of current systems is that all client wallet servers have a transaction reporting feature. Transactions originating from the client wallet server are logged with the client wallet server. Transaction reports enable the operator of the wallet server to ensure that only authorized transactions have originated from the wallet server. Transaction reports also alleviate the need to print physical invoice receipts at the time of the payment transaction. These reports have to be tracked by the cardholder, which if a number of different wallets and/or merchants are used, can become onerous. Therefore, it is preferable that the user be provided with a single consolidated report.

Accordingly, there is a need for a wallet server that operates on many platforms, is able to communicate with client wallet servers from multiple vendors and able to transact payments with multiple different financial hosts.

### SUMMARY OF THE INVENTION

In accordance with one aspect of this invention, there is provided a method of effecting a payment transaction between a client and a merchant, by interposing therebetween an entity for performing payment processing on behalf of the merchant website.

In accordance with another aspect the entity provides a uniform interface to the merchant regardless of the number of client wallets being transacted with.

In accordance with another aspect of the invention, there is provided a method for unifying payment transactions between a customer and a merchant, said transactions using customer information stored in one or more electronic wallets, said method comprising the steps of, providing to the merchant an entity having a unifying interface to said one or more electronic wallets, said entity communicating with both said one or more electronic wallets and said merchant; and said entity collecting customer information from said one or more electronic wallets and payment transaction details from said merchant and processing the transaction in a financial institution.

### BRIEF DESCRIPTION OF THE DRAWINGS

These and other features of the preferred embodiments of the invention will become more apparent in the following detailed description in which reference is made to the appended drawings wherein:

FIG. 1 is schematic diagram of a merchant payment system according to the prior art;

FIG. 2 is a schematic diagram of a merchant payment system according to one embodiment of the invention; and

FIG. 3 is a schematic diagram of a further embodiment of the merchant payment system.

### DETAILED DESCRIPTION OF THE PREFERRED EMBODIMENTS

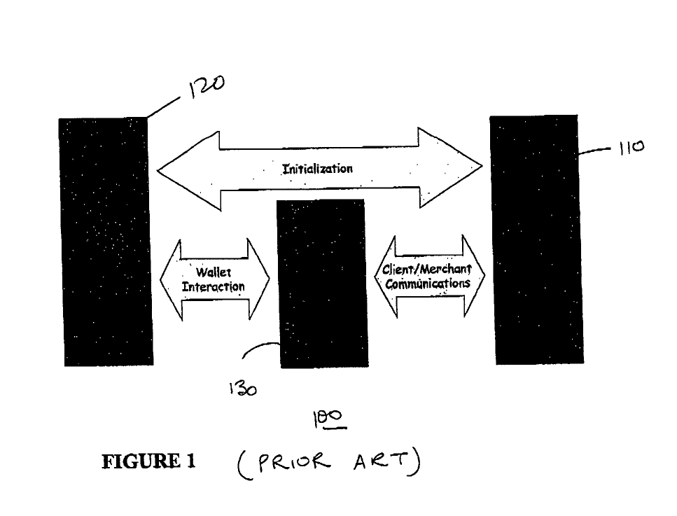

In the following description like numerals refer to like elements in the drawings. Referring to FIG. 1, there is illustrated a payment system architecture 100 according to the prior art. In this system, a merchant web site 110 includes a standard web server for serving web documents to potential customers over the internet. Their user or card holder 120 may transact with the merchant web site via a personal computer connected to the internet, a web enabled device or other similar means. Card holder information such as billing address, shipping address, credit card information, bank account information, and such like is stored in an electronic wallet or client wallet server 130, which the card holder can access also via the internet by providing for example, its user ID and password.

In use, the card holder 120 first initiates communication with the merchant web site 110 and selects the items or services from the merchant web site. When a payment transaction is required, such as when the card holder presses the “BUY” key on the merchant web page, the card holder interacts with his or her client wallet server. In this case, the merchant web site may be communicated to the client wallet server automatically. Upon receipt of this information, the client wallet server sends the client's information to the merchants web site. It is the responsibility of the merchant web site to perform the payment transaction using this information.

One disadvantage with this system may be explained as follows. Assume that the cardholders secret credentials is held in a client wallet server run by an issuing bank. A client wallet server is a holder of cardholder credentials run on behalf of the cardholder. To complete a payment transaction, a backend merchant system, will initiate communications with the client wallet server, obtaining a cardholder's credentials. All commercial implementations of client wallet servers are run behind a financial institution's firewall. These implementations are concerned with bi-directional authentication of both the mobile device and the client wallet server. However, the client is not assured that the merchant entity asking for cardholder credentials is an authentic and trusted merchant or that the system being used by the merchant is an authentic and trusted system.

One solution to the above problem is to introduce a trusted server that is able to communicate with client wallet servers from multiple vendors and to transact a payment with a multitude of different financial hosts. This trusted server is termed a merchant wallet server (MWS) which will be described below.

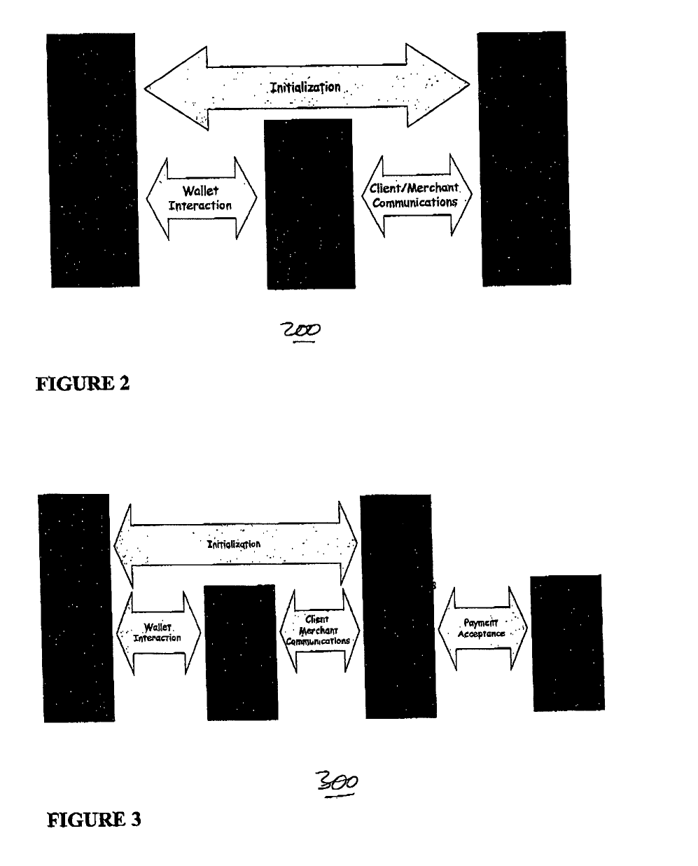

Referring to FIG. 2 there is shown a payment system incorporating an MWS according to one embodiment of the present invention. In this system, 200, the MWS is an entity positioned between the client wallet server and the merchant web site and effects transactions directly with a financial host.

In the system 200, the cardholder 120 initiates a payment transaction from the merchant website. Normally, the merchant website interacts directly with a client wallet server; however, the MWS acts as a proxy for the transaction. The MWS communicates with both the client wallet server and the merchant website. Client information is collected from the client wallet server. In addition, details of the payment transaction is collected from the merchant website. The MWS combines the information and processes the payment transaction. The result of the payment transaction is communicated to both the client wallet server and the merchant website. In effect, the MWS performs the payment processing obligation of the merchant website.

The MWS is designed such that it is independent of the specific client wallet server and of the merchant website. That is, the MWS is coded with specific adapters to available client wallet servers. Furthermore, the MWS provides a common unifying interface (or API's) to the merchant for performing payment processing and connectivity to client wallets. This alleviates the cost overhead of having to add new API's for each new client wallet being supported, by the merchant.

Referring now to FIG. 3, there is shown a payment system incorporating a merchant wallet server according to a second embodiment of the invention. In this system, 300 the merchant wallet system is used for person-to-person transactions. The card holder does not communicate directly with a merchant web site but initializes and performs the transaction with the merchant wallet server directly.

In the system 300, the cardholder initiates a payment transaction directly from his/her merchant wallet server account. This can be initiated from a variety of devices. For example, the cardholder can access a merchant wallet account from a mobile device or a personal computer. The cardholder supplies the necessary payment transaction details to the MWS. Similar to the case of payment via merchant website, the MWS combines the payment transaction information with client information for the client wallet server, and processes the payment transaction. The result of the payment transaction is communicated back to the first cardholder of the merchant wallet server and the second cardholder of the client wallet server.

Merchant Website to Merchant Wallet Server Interface:

The merchant wallet server communicates with merchant websites via a common software interface or API. This interface consolidates the existing client wallet server interfaces. The merchant wallet server to merchant website communications can be broken down into three main components. The first is client information from the client wallet server is sent to the merchant website. This is very similar to what client wallet server can do today in terms of form filling. The second component of the communications is the request of transaction details from the merchant website. These details are needed to process the payment transaction. The final component of the communications is the result of the payment transaction. The payment response information is sent after the payment transaction has been processed by the SAS.

Cardholder to Merchant Wallet Server Interface:

The merchant wallet server also allows payment transactions to be initiated directly from an account holder of the merchant wallet server. The merchant wallet server has a web server interface, allowing transaction requests to originate from its web server interface. This interface is accessible from a variety of form factors ranging from mobile devices to personal computers. Payment details are entered via the web interface. Once the payment transaction has been processed, the account holder of the merchant wallet server is notified of the result. The details of the payment transaction are also logged with the merchant wallet server. A transaction report can be retrieved at a later time.

Client Wallet Server to Merchant Wallet Server Interface:

The merchant wallet server communicates with a variety of different client wallet servers. Since client wallet server primarily exist as form filling entities for merchant websites, the merchant wallet server takes advantage of these software interfaces for extracting client information. Since client wallet servers hold transaction detail information, the merchant wallet server supplies the transaction details to the client wallet server. If any client wallet servers require the status of the particular transaction, the result of the payment transaction can also be communicated.

Merchant Wallet Server to Generic Payment Gateway:

The payment transaction may be forwarded to a generic payment gateway to the financial host. The response information is also sent back through the same channel ending up at the MWS. The response details are logged along with the information from the transaction request. Typically, the response information will contain the approval code sent from the financial host, One type of generic payment gateway is described in the applicants pending PCT application PCT/CA01/00549 incorporated herein by reference.

Merchant Wallet Server Logging Requirements:

As with client wallet servers, the merchant wallet server logs transaction details. The set of information includes payment details, payment response codes, and client wallet server information. A transaction report can be viewed, downloaded, or printed at any time by an account holder of the merchant wallet server.

Merchant Wallet Server Security Issues:

In the two use case scenarios, the merchant wallet server requires two levels of security. If the transaction is initiated by a cardholder interacting with a merchant website, the merchant wallet server does not communicate with a wireless entity. The merchant wallet server communicates with a client wallet server, a merchant website, and, internally, the SAS. All three communication types can be thought of as server to server communications. Server to server communications can be easily secured via standard Internet Secure Sockets Layer (SSL). SSL enables both message encryption and bi-directional authentication. If the transaction is initiated directly through the merchant wallet server's web interface, a wireless PKI mechanism is used to secure the communications between the user of the mobile device and the merchant wallet server. Wireless PKI solutions are currently available from a variety of vendors. The other communications required by the merchant wallet server are of the server to server type. As stated earlier, server to server type communications can be secured via standard SSL.

Merchant Wallet Server SSL Payment:

The merchant wallet server has the ability to engage in a payment transaction through an SSL payment gateway. SSL payment gateways are typically used by merchant websites for processing payment transactions. Essentially, an SSL connection is established between the SAS and the financial host, and the payment transaction request is sent through the SSL connection. The SSL connection provides a good level of security making use of keys for message encryption and certificates for bi-directional authentication.

Merchant Wallet Server SET Payment

The merchant wallet server has the ability to engage in a payment transaction through a Secure Electronic Transaction (SET) payment gateway or similar, such as 3-D Set; 3-D Secure. A SET transaction requires that the client wallet server be SET enabled. In addition, the payment transaction is processed via the SAS SET enabled gateway. The SET protocol provides a higher level of security compared to what is currently offered through an SSL payment gateway. Since the SET protocol requires both a SET based client entity and a SET based merchant entity, the transaction deals with the issue of non-repudiation.

Non-repudiation:

As in the description of SET payment, the SET protocol deals with the issue of non-repudiation. However, in the world of SSL type payments, the MWS also deals with the issue of non-repudiation. The client wallet server authorizes the request for payment. For a cardholder to accept the request for payment, the cardholder must first log onto the client wallet server. The fact that the cardholder has logged onto a client wallet server, combined with the level of security between a mobile device and the client wallet server, ensures that the client was present at the time of the payment. Most installations of client servers are hosted behind the firewall of issuing banks. Since the financial responsibility is with the issuing banks, all banks will require a secure connection between the mobile device and the client wallet server.

Authentication of Payment Processing Backend:

The merchant wallet server solution also deals with the issue of authentication the payment processing backend to the cardholder. In the case of traditional point of sale devices today, there is a certain level of trust between the cardholder and the merchant. Each device uses a very similar user interface, and each device will have logos of issuing banks.

In the case of consumer level mobile devices, there is not the same level of trust. However, because the MWS acting on behalf of the merchant, would process the payment transaction on behalf of the merchant. A payment transaction is triggered by a payment request from the merchant to the MWS. This MWS then requests cardholder credentials from a client wallet server and processes the payment transaction using those credentials to a financial host.

Next, assuming that the system is set-up with a cardholder secret, then, since the MWS holds the key used to encrypt the cardholder secret, this key is first encrypted with the MWS public key and passed through the backend system to the client wallet server. The client wallet server (or some system such as a client wallet secret server acting on behalf of the client wallet server), then decrypts the key used originally to encrypt the cardholder secret and then decrypts the actual cardholder secret and sends this back to the MWS via some secure method. The MWS then forwards this secret to the merchant payment acceptance system or to some other system owned by the cardholder (such as the cardholder's cell phone or home computer). Then the cardholder's secret is shown to the cardholder prior to the cardholder giving final authorization to proceed with the payment. In this way, the cardholder is assured that he/she is dealing with a trusted system and a trusted merchant prior to providing final authorization to proceed with the transaction as only a trusted merchant using a trusted system would have been able to disclose the cardholder secret to the cardholder.

It may be seen, that the present system provides a relatively simple and efficient method for the customer to authenticate the merchant. The present invention may be used to extend existing standards for electronic transactions such as SET. The SET standards specify secure means for electronic transactions. Specifically, they address the situation of a cardholder paying for goods from their home computer over the World Wide Web. There are two key assumptions, specifically, the home computer, is trusted by the cardholder and a magnetic stripe card account is used. On the other hand, the NV96 standards enhance SET for the use of IC cards or smart cards. Like SET, the EMV standard assumes that a trusted device, typically a home computer, is used for transactions. Accordingly, with the present invention, security concerns associated with the use of generic devices may be ameliorated with the use of IC cards in place of magnetic stripe cards.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method for unifying payment transactions between a customer and a merchant, said transactions using customer information stored in one or more electronic wallets, said method comprising the steps of:
providing to the merchant an entity having a unifying interface to said one or more electronic wallets, said entity communicating with both said one or more electronic wallets and said merchant; and
said entity collecting customer information from said one or more electronic wallets and payment transaction details from said merchant and processing the transaction in a financial institution.

2. A method as defined in claim 1, including said entity communicating results of said payment transaction to both said one or more electronic wallets and said merchant.

3. A method as defined in claim 1, said entity being a server.
